(19) United States
(12) Patent Application Publication
(10) Pub. No.: US 2005/0230188 A1
(43) Pub. Date: Oct. 20, 2005

(54) Saw horse with adjustable height and length top rail

(76) Inventor: Joel J. Berg, Chicago, IL (US)

Correspondence Address: CHARLES F. LIND & ASSOCIATES;ATTORNEYS AT LAW, SUITE 300, 120 W. EASTMAN, ARLINGTON, IL, 60004-5950, US

(21) Appl. No.: 10/826,032

(22) Filed: Apr. 19, 2004

(51) Int. Cl. B60P 7/02; E04G 1/34

(52) U.S. Cl. 182/153

(57) ABSTRACT

The disclosed portable sawhorse has a collapsible base formed of two side panels pivoted together, with a top rail having spaced end legs telescopically connected at U-shaped holders to one of the side panels for top rail movement between varied vertical spacings above the base. A latch pivoted to each holder is shifted between a position engaging the end leg for holding the top rail at selected spacings above the base and other positions allowing top rail movement. In the engaging position, the latch bottoms against the end leg with forces proportional to the top rail loads. Extenders carried on the top rail can be shifted to change effective top rail lengths. The side panel not carrying the top rail holders has upper edges that engage the top rail end legs operable to directly transmit via this side panel part of the top rail load.

### BACKGROUND OF THE INVENTION

Sawhorses are commercially available, purchased and used in part because they are lightweight, collapsible, and relatively inexpensive, while yet being highly effective to provide for constructing a platform or support between operating pairs of sawhorses. Simplifying the component parts and the manner and effort needed for their assembly also has reduced the cost of sawhorses, helping this trend of acceptance and use.

My U.S. Pat. No. 6,422,343 B1, issued Jul. 23, 2002, disclosed a COLLAPSIBLE SAWHORSE that had many related features and advantages, and its teachings are to be incorporated herein for disclosure of structures possibly not fully illustrated herein.

Following this concept, adding the features for adjusting the load supporting top rail, in so far as its height above the supporting surface and/or its horizontal length, would offer even further user appeal.

### SUMMARY OF THE INVENTION

This invention relates to and an object of this invention is to provide an improved collapsible sawhorse, having separate components that are economically injection molded and rapidly and easily assembled, while further having the features that the load supporting top rail can be adjusted, both in its height above the supporting surface and/or in its horizontal length.

### BRIEF DESCRIPTION OF THE DRAWINGS

This and other objects, features or advantages of this invention will be more fully understood and appreciated after consideration of the following description of the invention, which includes the accompanying drawings, wherein:

FIG. 1 is a top plan view of the improved sawhorse, shown in an opened operative condition;

FIG. 2 is a front elevational view of the FIG. 1 sawhorse;

FIG. 3 is an end elevational view of the FIG. 2 sawhorse;

FIG. 4 is an end elevational view similar to FIG. 3, except showing the sawhorse in its closed condition;

FIG. 5 is an end elevational view similar to FIG. 3, except showing the sawhorse with its top rail in an elevated position;

FIG. 6 is an exploded perspective view of major components making up the sawhorse of the previous figures;

FIG. 7 is perspective view of a pocket or holder used for supporting the top rail side bar;

FIG. 8 is a perspective view of a portion of the opened sawhorse, showing a height adjustment latch disengaged from the top rail side bar;

FIG. 9 is a perspective view similar to FIG. 8, except having the one side panel, that holds the illustrated top rail side leg and latch mechanism, eliminated and showing also the hidden side of the other side panel;

FIG. 10 is a view from the underside of the top rail, showing linkage for moving the extender bars symmetrically between different closed and expanded positions;

FIG. 11 is a sectional view as seen generally from line 11-11 in FIG. 10;

FIG. 12 is a sectional view of the top rail latch shown in the engaged locking position with the side bar;

FIG. 13 is a sectional view of supplemental support mechanism operable between the side panel not carrying the top rail and the top rail end leg, for distributing a top rail load between the two connected side panels; and

FIG. 14 is a perspective view of a clip used for forming the support mechanism of FIG. 13.

### DETAILED DESCRIPTION OF THE INVENTION

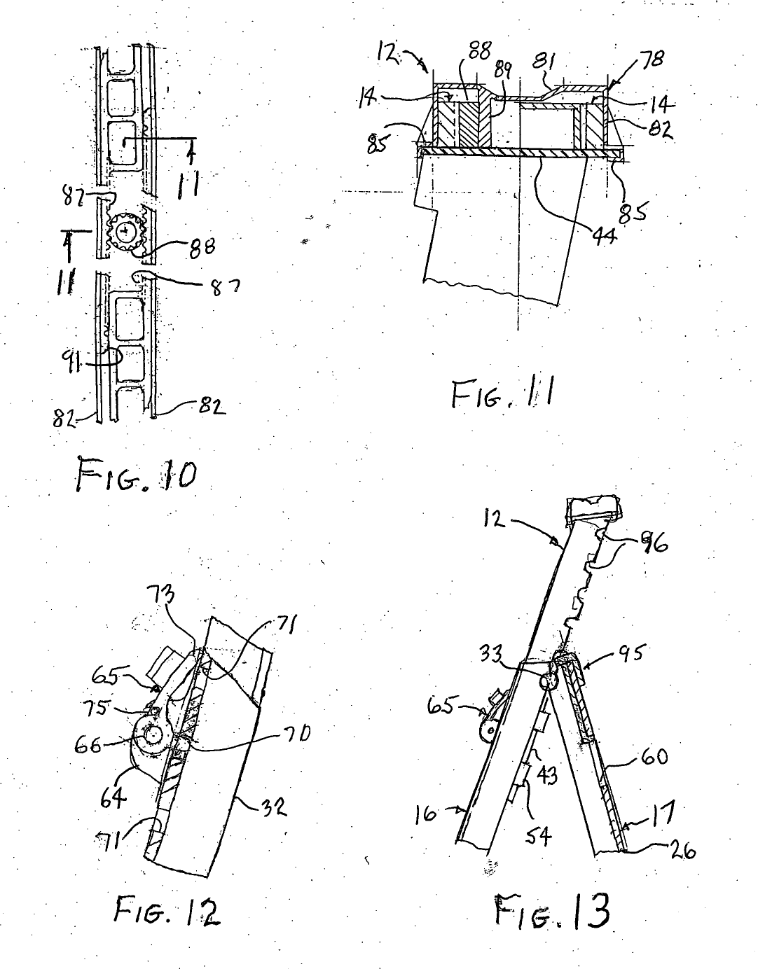

The illustrated sawhorse has a base 10 and an overlying workpiece carrying top rail 12. The top rail 12 is moveable between a lowered position illustrated in FIGS. 1-4, and raised positions as illustrated in FIGS. 5, 13. This provides that an object supported on the top rail 12 can be adjusted to different heights above the underlying supporting ground or floor. Further, extender bars or wings 14 (see FIGS. 6, 12) are mounted on the top rail 12, moveable axially of the top rail between a retraced position of FIG. 2 and adjusted extended positions that provide different sawhorse support widths.

The base 10 is comprised of two identical side panels 16, 17 and a utility tray 18 comprised of two identical panels 20. Each base panel 16, 17 can have two upstanding legs 22 and upper and lower cross beams 23, 24 extended between the legs. The legs 22 and cross beams 23, 24 have a common generally flat front wall 26, and substantially continuous flanges 28, 30 perpendicularly angled rearwardly away from the inner and outer front wall edges and terminating along a generally planar rear edge 32 generally parallel to the front wall 26.

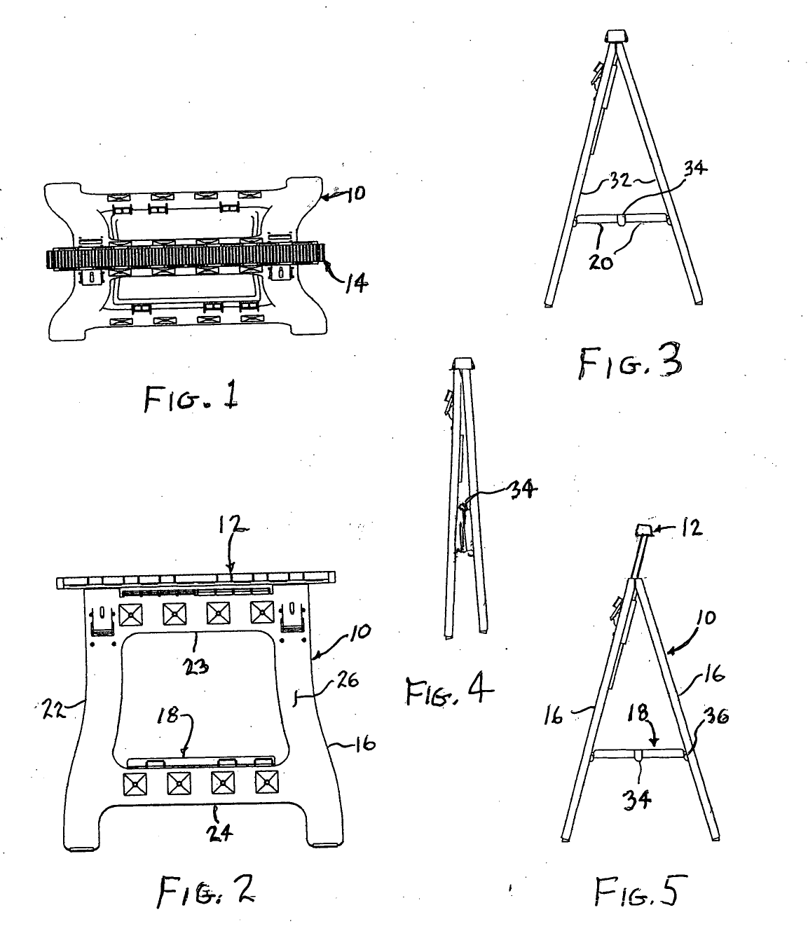

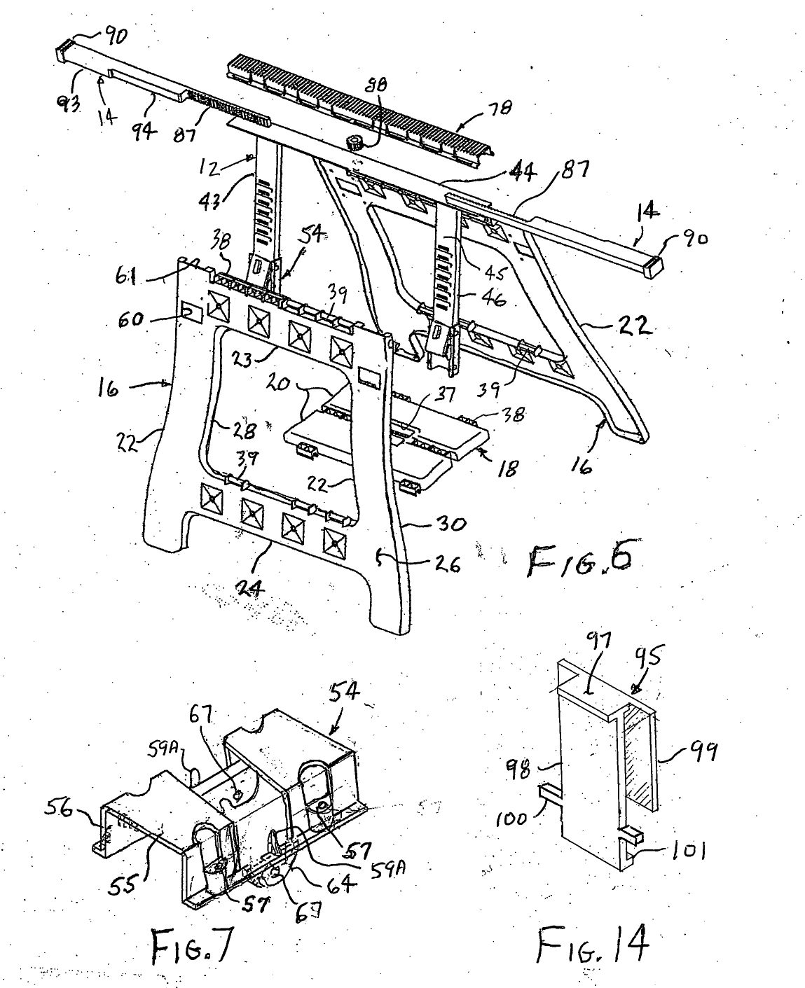

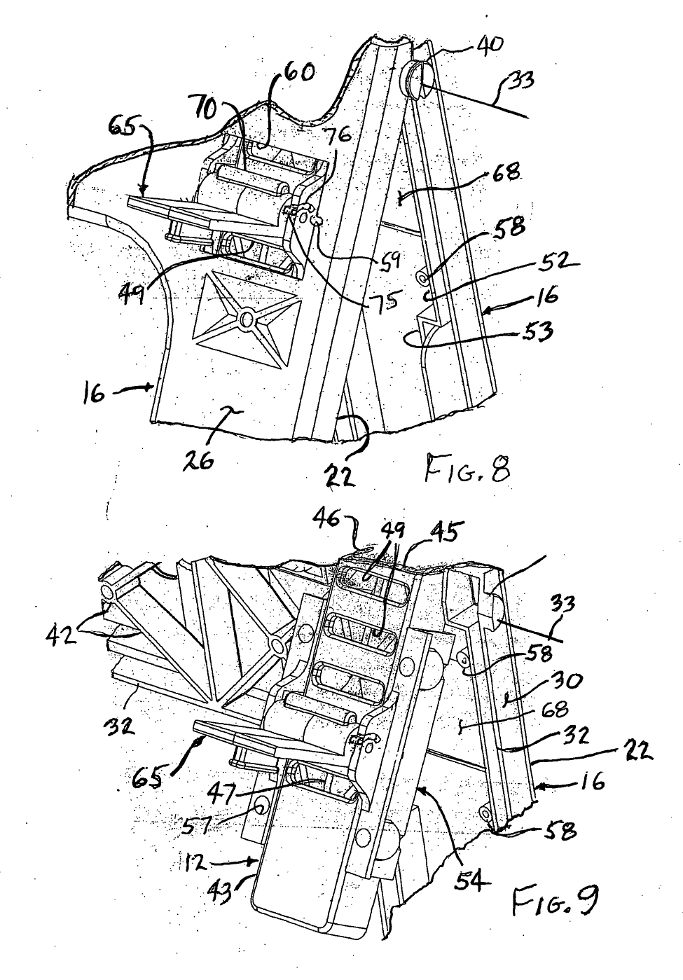

The two base side panels 16, 17 are hinged together proximate the respective upper cross beams 23, to pivot about generally horizontal axis 33 (FIGS. 8, 9, 13). The two tray panels 20 are hinged together along medial edges 34 and are hinged at the outward edges 36 onto the lower cross portions 24. This allows the base 10 to be shifted between the illustrated opened position for stable sawhorse support on a generally flat horizontal support surface and the collapsed condition (FIG. 4). The tray panels 20 can be pulled upwardly at the medial hinged edges 34 via hand hole 37, which draws the side panels 16, 17 together, so that the side and tray panels then lie generally parallel and side by side. The tray at the hole 37 can further be gripped for carrying the closed sawhorse with one hand.

The above hinging connections at axis 33 can be achieved in part according to my above mentioned U.S. Pat. No. 6,422,343 B1. Thus, cylindrically curved open-sided hooks 38 (FIG. 6) can be aligned along part of each panel and shafts 39 can be aligned along its remainder, with the hooks and shafts being coaxial and properly spaced apart laterally and symmetrically from the panel center so that when the side and the tray panels are rotated to face one another, the hooks and shafts can be interlocked together pivotally. Segmented end pins 40 (FIGS. 8, 9) projected coaxially along axis 33 can be held together by a slip ring (not shown) fitted over the pins, to hold the panel edges together.

Each side panel 16, 17 can be reinforced by crossing webs 42 (FIG. 9) integrally projected from the hidden side of the front wall 26 and peripheral flanges 28, 30 and each other, as by injection molding the side panels of plastic.

The top rail 12 (FIG. 6) is comprised in part of rigid generally parallel end bars or legs 43 and a cross bar 44 extended therebetween. The end legs 43 preferably have a generally rectangular cross-section, with a flat exposed front wall 45, side flanges 46 rearwardly projected therefrom, and reinforcing crossing rear webs 47 integral with the front wall and flanges. Each leg front wall 45 has a number of openings 49 therein uniformly spaced apart along its length, much in the manner of cross rungs on a ladder.

Mounting structures cooperate between the end legs 22 of the base side panel 16 and the top rail end legs 43, operable to hold the top rail 12 laterally stable while allowing it to be telescopically adjusted between different vertical spacings above the base 10 and/or the horizontal surface. The mounting structure is formed by eliminating any reinforcing webs 42 in the side panel legs 22 between interior walls 52, 53 projected from the front wall 26; and by securing a U-shaped pocket or holder 54 (FIG. 7)to the front wall 26 between these one side panel walls.

Each pocket or holder 54 has a rear wall 55 and spaced flanged side walls 56, and can be secured from the rear side of the end legs by positioning stepped holder openings 57 snuggly over end leg rear bosses 58 (FIGS. 8, 9), and by tightening headed screws (not shown) stopped at the smaller of the stepped openings 57 and threaded into taps in the leg bosses 58. Added holder stability can be achieved by fitting locator ribs 59 (aligned with but oppositely extended from rib 59A visible in FIG. 7) snuggly into small cutouts off of side panel front wall opening 60. The side panel outer flange 30 is cut away as at 61 (FIG. 6) to receive each top rail end leg 43 (or a support clip 95 (FIGS. 14, 15) to be discussed later.

The side panel walls 53 and holder side walls 56 can be lined up, and these and the rear side of the panel wall 26 and the front side of the holder wall 55 can be spaced apart to receive with minimal clearance the top rail end legs 43.

Each holder 54 has laterally spaced ears 64 that will, when the holder is secured to the side panel, project through the front wall opening 60 and forwardly from the front wall 26. A latch 65 is pivoted to the ears by a pin 66 fitted through a latch opening and through aligned ear openings 67. The pin 66 can be comprised of two separate headed pieces inserted from the outward sides of the ears 64 to cause meshing barbs or the like (not shown) to become interlocked within the latch opening. The side panel 17 not carrying the top rail 12 can have separate pieces 68 snapped onto the front wall to cover the opening 60.

Each latch 65 further has a radially extended lug 70 that upon latch rotation can be butted against the top rail end leg front wall 45, and fitted into any opening 49 therein when properly aligned therewith. The latch pivot pin 66 is forwardly spaced from the lug engagement with the end leg 43, so that downward end leg movement rotates the latch (clockwise in FIG. 12) until its free end 73 bottoms against the end leg. The bottomed latch structurally prohibits further downward top rail movement, and the latch lug 70 is then engaged against the upper edge of the opening 49.

However, when a user attempts to move the sawhorse (with no load on it) by lifting it from the top rail, the upward end leg movement and accompanying lug engagement shift against the lower opening edge could rotate the latch to disengage it, thereby allowing the set top rail height adjustment to be changed.

To prevent this latch disengagement, retainer pins 75 (FIGS. 8, 9, 12) are axially extended off of the latch 65 operable to fit, when the latch is in the locking position, within curved slots 76 in the holder ears 64. Some vertical clearance will be provided also between the lug and the upper and lower edges of the end leg openings 49 when in the locking position. As such, the pins 75 will bottom against the ear at slots 76, before the lug can be shifted to engage against the lower side leg opening edge. The pins 75 need be structural enough only to carry the sawhorse weight when the sawhorse is lifted by the top rail. When the lifting force is removed from the top rail and a downward top rail load prevails, the latch lug 70 will again engage the upper opening edge and the latch pins 75 will loosely fit in the ear slots 76.

The top rail 12, in addition to the elongated extenders 14 and cross bar 44, is comprised of an open-ended inverted “U” shaped cap 78 that is locked onto the cross bar for generally enclosing the rail extenders. Specifically, cap top wall 81 and side walls 82 angled therefrom, respectively define generally parallel inner faces, which with the parallel upper face of the cross bar 44 laterally contain the extenders 14 while allowing them to move axially into and out of the open cap ends. The lower portions of the cap side walls 82 form generally parallel alternately arranged upper and lower lips 85 suited to receive therebetween the opposite side edges of the cross bar 44, for mechanically connecting the cap and cross bar together. The united association of the components 14, 44, 78 provide the needed top rail beam strength.

A projection 86 (FIG. 11) laterally wider than the lower lips but narrower than the side wall connecting the lips together, can be located to fit between the lower lips when the cap is properly placed on the cross bar. This can firmly secure the cap against unwanted movement along the cross bar 44.

The top rail extenders 14 (FIGS. 6, 7, 10, 11) have one end configured as a toothed rack 87 that can simultaneously engage opposite sides of a pinion 88 rotated on a post 89 projected from the cap top wall 81. This correlates the extending and retracting extender movements symmetrically centered on the top rail. Enlarged heads 90 on the extenders engage the opposite cap ends with the extenders fully retracted, and stops 91 on the innermost rack ends engage the pinion 88 with the extenders fully extended. Each extender 14 spaced endwardly from the rack has two different cross sections, outer sections 93 sized to fit slidably between the confining cap side wall 82 during part of the extender movements and intermediate section 94 sized to fit with the adjacent rack slidably between the confining cap side walls during all of the extender movements. Axially extended guides (not shown) formed off of the cap top wall can engage the intermediate cap section 94 when the outer sections 93 are withdrawn from the surrounding confines of the cap.

Although the four side panel legs 22 provide stable sawhorse support during use, the telescopic supports provided between the holders 54 and the top rail end legs 43 seem to drive a larger percent of the top rail load axially of that side panel 16; while the other side panel 17 can serve merely to prop up that holder bearing side panel 16 via the connection between the side panels at pivot 33. On the other hand, as the raised top rail 12 is laterally shifted off center of the pivot 33 and the base 10, to overlie the side panel 17 more than the holder carrying side panel 16 due to the converging inclination each side panel has at the common pivot 33, the side panel 17 possibly can end up carrying a greater percent of the top rail load. These conflicting factors and possible causes for load imbalances can be neutralized to a great extend by the following structures.

Thus, clips 95 (FIGS. 13, 14) are secured onto the upper ends of the side panel 17 at the flange cutouts 61, suited to fit into horizontally aligned notches 96 formed in the rear sides of the two top rail end legs 43. The notches 96 can be formed by removing the forward portions of some of the reinforcing webs 47. The notches 96 and latch openings 71 in the end legs 43 will be provided at the same spacings along the end legs, so that when the latch lug 70 is fitted into one opening the clip will be fitted into a corresponding notch.

As proposed, the clips 95 will engage the top rail end legs 43 vertically spaced above and laterally offset from the pivot axis 33. These clip engagements against the rear sides of the end legs 43 can redistribute the top rail load beneficially between the side panels 16, 17, as part of the top rail load from the engagements is directly applied to the side panel 17, and these clip-side panel engagement locations more directly underlie the top rail 12 and are closer to the side panel 17 than to the holder carrying side panel 16.

Specifically, the clip 95 can have a top wall 97 and spaced rear and front legs 98, 99 depending from the top wall suited to straddle and fit over the front wall 26 of the side panel 17. The top wall 97 is extended rearwardly away from the side panel wall 26 in the form of a ledge operable to fit into the rear notch 96 on the top rail end leg. The ledge width can be slightly less than the spacing between the flanges 46 of the end legs. While the rear clip leg 98 can be the same width as the illustrated ledge width, spacer pins 100 beneficially can be formed off of the side edges to provide an overall width just shy of hitting the flanges 28, 30 of the side panel 16, for quick and easy clip centering within the cutout 61. The rear leg 98 can have an outwardly directed lower lip 101 suited to fit into the front wall opening 60 of the side panel 17, for underlying and engaging the upper opening edge and stabilizing and securing the clip supported on the side panel. For appearance reasons primarily, the front leg 99 can be made the same width as the latch 65.

The clip top wall ledge 97 will engage the side panel 16 at the notch 96 when the sawhorse is operatively opened and positioned on a support surface, while it will become spaced and separated therefrom when the sawhorse is closed (FIG. 4).

While a specific sawhorse embodiment has been illustrated, minor changes could be made without departing from the overall spirit of the inventive teaching. Accordingly, the invention is to limited only by the scope of the following claims.

1. A portable sawhorse comprising the combination of
a base having a pair of side panels each with generally parallel end legs and an upper cross portion extended therebetween, and means hinging the upper cross portions together for side panel movement between a closed position and an opened position suited for stable support on a generally horizontal surface;
a top rail having generally parallel end legs and a cross bar extended therebetween, and telescoping structures mounting the end legs to move in opposite directions relative to the base operable to locate the cross bar at varied vertical spacings above the horizontal surface; and
a latch pivoted to the telescoping structure for rotation about a generally horizontal pivot axis, the latch having a lug radially extended from the pivot axis and operable in one latch position to engage the adjacent end leg for locking the cross bar at selected vertical spacings relative to the base, and said latch having an end that is rotatably bottomed relative to the end leg as load is applied to the cross bar for structurally maintaining the cross bar in any selected vertical spacing even as greater loads might be carried thereon.

2. A portable sawhorse according to claim 1, further comprising said latch pivot axis being laterally offset from the lug engagement with the end leg and said latch end being at a radial distance from the pivot axis substantially greater than the radial distance from the pivot axis of the lug engagement with the end leg.

3. A portable sawhorse according to claim 2, further comprising each latch and its pivot axis being located on the outward sides of the end leg, and said one latch position having the latch pivot axis located below the bottomed location of the latch end relative to the end leg.

4. A portable sawhorse according to claim 1, further comprising retaining structures on the end legs and latch for holding said latch fixed relative to the end leg while in the one latch position, said retaining structures becoming engaged and operative only upon an upward force being applied to the cross bar suited for lifting the base off of the horizontal surface.

5. A portable sawhorse according to claim 1, further comprising said top rail having a pair of elongated rigid generally straight extenders supported relative to the cross bar in generally side by side association, and means allowing the extenders to be moved relative to one another along their lengths between withdrawn positions where outward ends of the extenders are at one generally horizontal separation and extended positions where said outward extenders ends are at greater separations.

6. A portable saw horse according to claim 1, further comprising said telescoping structures include separate elongated open ended generally U-shaped members sized to fit respectively against each end leg of one of the base side panels and be aligned therewith, and means securing the elongated members relative to the base end legs for mounting said top rail end legs telescopically therein.

7. A portable saw horse according to claim 6, further comprising each end leg of the one base side panel having an opening therein, and each elongated member having mounting ears suited to extend through the side panel opening to be forwardly spaced therefrom, and said latch being pivoted to the mounting ears at said generally horizontal pivot axis forwardly spaced from the adjacent top rail end leg.

8. A portable saw horse according to claim 1, further comprising the other side panel forming the base having a upper edge disposed vertically above and rearwardly offset from the pivot axis in the direction away from the one side panel and toward the other side panel, the top rail end legs having notched formed therein and defining downwardly facing edges, and the other side panel upper edges being disposed to engage the downwardly facing notch edges when the sawhorse is opened to directly transmit via the other side panel part of the load carried on the top rail to the supporting surface.

9. A portable saw horse according to claim 8, further comprising said telescoping structures include separate elongated open ended generally U-shaped members sized to fit respectively against each end leg of one of the base side panels and be aligned therewith, and means securing the elongated members relative to the base end legs for mounting said top rail end legs telescopically therein.

10. A portable saw horse according to claim 9, further comprising each end leg of the one base side panel having an opening therein, and each elongated member having mounting ears suited to extend through the side panel opening to be forwardly spaced therefrom, and said latch being pivoted to the mounting ears at said generally horizontal pivot axis forwardly spaced from the adjacent top rail end leg.

11. A portable sawhorse according to claim 10, further comprising retaining structures on the end legs and latch for holding said latch fixed relative to the end leg while in the one latch position, said retaining structures becoming engaged and operative only upon an upward force being applied to the cross bar suited for lifting the base off of the horizontal surface.

12. A portable sawhorse according to claim 10, further comprising said top rail having a pair of elongated rigid generally straight extenders supported relative to the cross bar in generally side by side association, and means allowing the extenders to be moved relative to one another along their lengths between withdrawn positions where outward ends of the extenders are at one generally horizontal separation and extended positions where said outward extenders ends are at greater separations.
